(19) United States
(12) Patent Application Publication
(10) Pub. No.: US 2019/0363651 A1
(43) Pub. Date: Nov. 28, 2019

(54) POWER TOOL

(71) Applicant: MOBILETRON ELECTRONICS CO., LTD., Taichung City (TW)

(72) Inventors: SHIH-HAO WANG, Tainan City (TW); WEN-SHING HON, Taichung City (TW)

(73) Assignee: MOBILETRON ELECTRONICS CO., LTD., Taichung City (TW)

(21) Appl. No.: 16/418,624

(22) Filed: May 21, 2019

(30) Foreign Application Priority Data
May 25, 2018 (TW) 107117937

(51) Int. Cl. H02P 6/16; H02P 29/00; H02K 7/14; B25F 5/00

(52) U.S. Cl. CPC H02P 6/16; B25F 5/001; H02K 7/145; H02P 29/00

(57) ABSTRACT

A power tool comprises a housing, a motor, a first circuit board, and a second circuit board. The housing includes a transmission portion and a handheld portion. The motor and the first circuit board are arranged in the transmission portion, and the second circuit board is disposed in the handheld portion. The first circuit board is provided with a plurality of commutating switch components, a plurality of Hall sensors, and a first controller. The first controller receives a driving signal and controls the commutating switch components to perform commutation according to the driving signal and the position signal from the Hall sensors. The second circuit board is electrically connected to the first circuit board through a transmission line set and provided with a second controller, which transmits the driving signal to the first controller via the transmission line set. Thus, the number of signal lines of the transmission line set between the first circuit board and the second circuit board can be effectively reduced.

### BACKGROUND OF THE INVENTION

### Technical Field

The present invention is related to a power tool, and, more particularly, to a design that facilitates wiring within the housing of a power tool.

### Description of Related Art

FIGS. 1 and 2 show a conventional power tool 1, which includes a housing 10, a motor 14, an upper circuit board 16 and a lower circuit board 18. The housing 10 has a transmission portion 102 and a handheld portion 104. The transmission portion 102 is provided with a motor 14, e.g. a three-phase brushless DC motor, and a driving mechanism (not shown), and the handheld portion 104 is provided with an operation interface 12 for the operator to operate and generate an operation signal.

The upper circuit board 16 is arranged at the transmission portion 102 and provided with six commutating switch components 162 which are used to control the commutation of the motor and three Hall sensors 164 that sense a position of a rotor of the motor 14.

The lower circuit board 18 is disposed in the handheld portion 104 of the housing 10 and electrically connected to a battery connection port 20 to receive power from the battery 22, and a controller 182 is arranged on the lower circuit board 18. The lower circuit board 18 is electrically connected to the operation interface 12 so that the controller 182 can receive the operation signal from the operation interface 12. The lower circuit board 18 is electrically connected to the upper circuit board 16 through a transmission line set 24. The transmission line set 24 includes nine control signal lines for transmitting the control signals for the commutating switch components 162 and five position signal lines for transmitting the output signals of the Hall sensors 164. After receiving the operation signal from the operation interface 12, the lower controller 182 generates control signals for controlling the commutating switch components 162 according to the operation signal and the output signals of the Hall sensors from the five position signal lines. The control signals are then transmitted to the commutating switch components 162 of the upper circuit board 16 via the nine control signal lines to control the commutating switch components 162 to perform commutation, which causes the rotor of the motor 14 to rotate.

Since at least 14 signal lines are required for the transmission line set 24 between the upper circuit board 16 and the lower circuit board 18, the arrangement of 14 signal lines in the limited space between the handheld portion 104 and the transmission portion 102 will lead to overcrowding, which is not conducive to the wiring of the transmission line set 24 during assembling.

### BRIEF SUMMARY OF THE INVENTION

In view of the above, the purpose of the present invention is to provide a power tool that can reduce the number of signal lines of a transmission line set and facilitate wiring in the housing.

In order to achieve the above object, the present invention provides a power tool, which comprises a housing, a motor, a first circuit board, and a second circuit board. The housing comprises a transmission portion and a handheld portion, and the motor is disposed in the transmission portion. The first circuit board is disposed in the transmission portion of the housing and provided with a plurality of commutating switch components, a plurality of Hall sensors and a first controller. The first controller is electrically connected to the commutating switch components and the Hall sensors; and the commutating switch components are electrically connected to the motor. The Hall sensors sense a position of a rotor of the motor and generate a position signal. The first controller receives a driving signal and controls the commutating switch components to perform commutation according to the driving signal and the position signal in order to rotate the rotor of the motor. The second circuit board is disposed in the handheld portion of the housing, electrically connected to the first circuit board through a transmission line set, and provided with a second controller, which transmits the driving signal to the first controller via the transmission line set.

The advantage of the present invention is that the switching of the commutating switch components is controlled by the first controller on the first circuit board, such that the number of signal lines of the transmission line set between the first circuit board and the second circuit board can be effectively reduced, thereby facilitating the wiring of the transmission line set in the limited space between the handheld portion and the transmission portion of the housing.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of a conventional power tool;

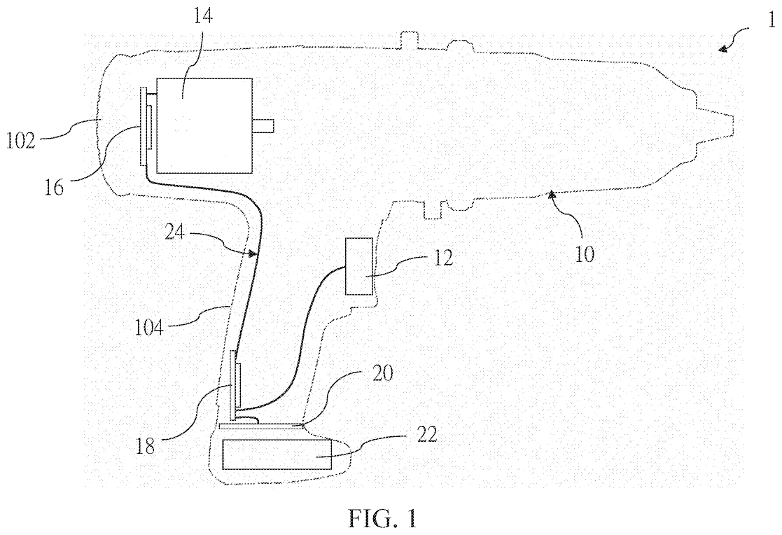

FIG. 2 is a system block diagram of a conventional power tool;

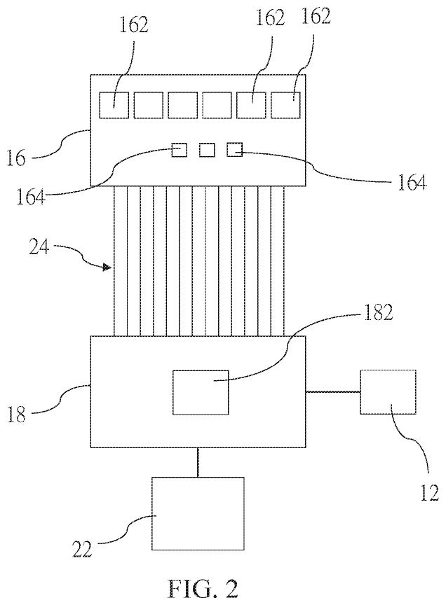

FIG. 3 is a schematic view of a power tool in accordance with a preferred embodiment of the present invention;

FIG. 4 is a system block diagram of the power tool of the above preferred embodiment;

FIG. 5 is a perspective view showing a motor of the power tool of the above preferred embodiment;

FIG. 6 is an exploded perspective view showing the motor of the power tool of the above preferred embodiment; and

FIG. 7 is a waveform diagram showing the outputs of the three Hall sensors and the rotational speed signal of the above preferred embodiment.

### DETAILED DESCRIPTION OF THE INVENTION

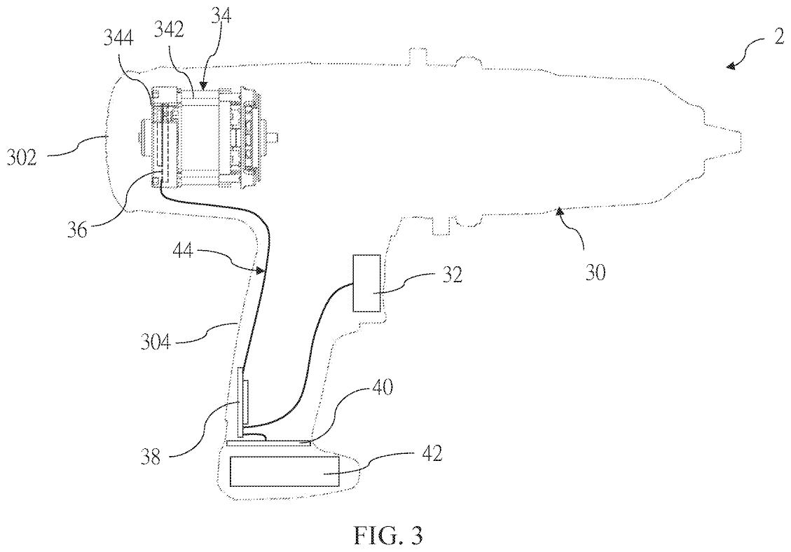

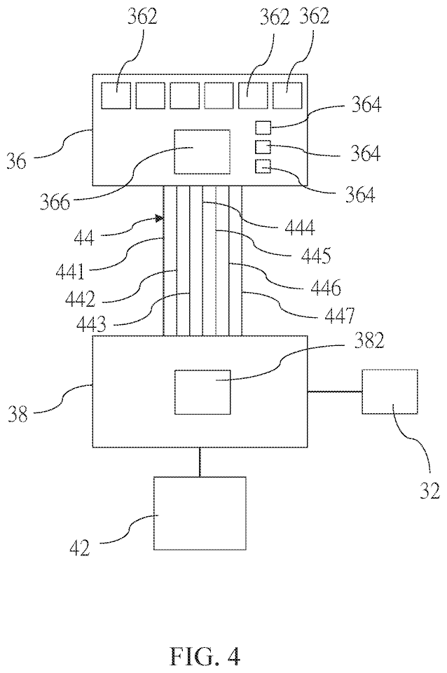

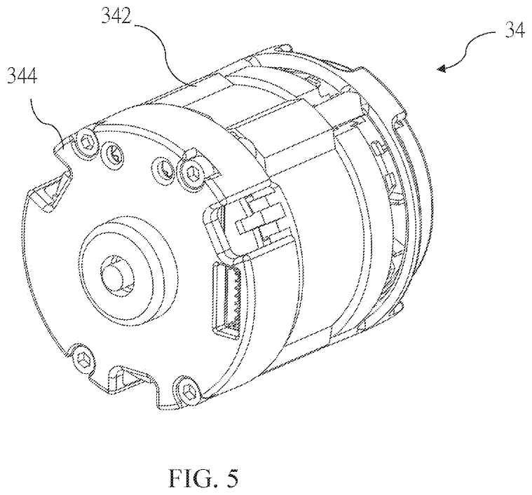

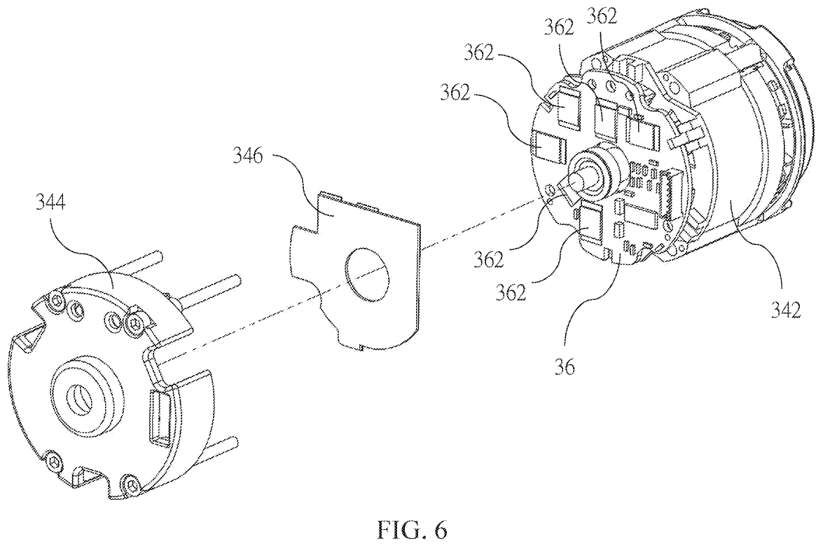

In order to more clearly illustrate the present invention, a preferred embodiment is described in detail with reference to the drawings. Referring to FIG. 3 to FIG. 6, a power tool 2 according to the preferred embodiment of the present invention includes a housing 30, a motor 34, a first circuit board 36 and a second circuit board.

The housing 30 includes a transmission portion 302 and a handheld portion 304. The transmission portion 302 is provided with a motor 34 and a driving mechanism (not shown), which is driven by a rotating shaft of the motor 34. The handheld portion 304 is arranged for the operator to hold and provided with an operation interface 32. The operation interface 32 is arranged for the operator to operate and thus generate an operation signal. In this embodiment, the operation interface 32 includes a start switch and a rotation switch, and the operation signal includes a start command, a rotation command, etc. In practice, the operation interface includes at least the start switch, and the operation signal includes at least the start command.

In this embodiment, the motor 34 is a three-phase brushless direct current motor and includes a body 342, a rear cover 344, and a heat dissipation pad 346. A stator (not shown) and a rotor (not shown) are provided inside the body 342. The motor 34 has a rotary shaft coupled to the rotor and the driving mechanism and protruding from a front side of the body 342. The rear cover 344 is disposed at the rear side of the body 342, the heat dissipation pad 346 is disposed between the rear cover 344 and the body 342, and the heat dissipation pad 346 has a heat conduction relationship with the rear cover 344. The heat conduction relationship may mean the heat conduction via the direct contact or thermal grease between the heat dissipation pad 346 and the rear cover 344.

The first circuit board 36 is disposed in the transmission portion 302 of the housing 30. In this embodiment, the first circuit board 36 is disposed between the body 342 and the heat dissipation pad 346. The first circuit board 36 is provided with a plurality of commutating switch components 362, a plurality of Hall sensors 364, and a first controller 366. The first controller 366 is electrically connected to the commutating switch components 362 and the Hall sensors 364. In the present embodiment, the commutating switch components 362 are six MOSFET stators that are electrically connected to the motor 34. The commutating switch components 362 have a heat conduction relationship with the heat dissipation pad 346. The heat conduction relationship may mean the heat conduction via the direct contact or thermal grease between the commutating switch components 362 and the heat dissipation pad 346. There are three Hall sensors 364, which respectively sense the position of the rotor of the motor 34. The output of each of the Hall sensors 364 is changed between a first voltage level and a second voltage level. Whenever the rotor rotates 120 degrees, the Hall sensors 364 respectively output pulse waves in sequence to form a position signal in the form of a pulse wave. The first controller 366 receives a driving signal and controls the commutating switch components 362 to perform commutation according to the driving signal and the position signal in order to rotate the rotor of the motor 34. In this embodiment, the first voltage level is exemplified by a low voltage level, and the second voltage level is exemplified by a high voltage level.

The second circuit board 38 is located in the handheld portion of the housing 30, electrically connected to the battery connection port 40 to receive power from the battery 42, and provided with a second controller 382. Also, the second circuit board 38 is electrically connected to the operation interface 32, so that the second controller 382 receives the operation signal from the operation interface 32 and converts the operation signal into the driving signal. In addition, the second circuit board 38 is electrically connected to the first circuit board 36 through a transmission line set 44, so that the second controller 382 transmits the driving signal to the first controller 366 via the transmission line set 44.

Therefore, after receiving the driving signal, the first controller 366 can control the commutating switch components 362 to perform commutation according to the driving signal and the position signal to rotate the rotor of the motor 34. Since the commutation control is performed by the first controller 366 disposed at the first circuit board 36, the second controller 382 disposed at the second circuit board 38 need not individually control the commutating switch components 362 to perform commutation. Therefore, the power tool 2 of the present invention can effectively reduce the number of signal lines in the transmission line set 44, compared to the conventional power tools.

In this embodiment, the transmission line set 44 includes a speed signal line 441 and a brake signal line 442. The driving signal generated by the second controller 382 according to the start command of the operation signal includes at least a speed command and a braking command The speed command is transmitted through the speed signal line 441, and the braking command is transmitted through the brake signal line 442. After receiving the driving signal, the first controller 366 controls the switching speed of the commutation performed by the commutating switch components 362 according to the speed command to achieve the control over the rotational speed of the rotor, or controls the commutating switch component 362 according to the braking command to stop the rotation of the rotor. In this embodiment, the speed command is transmitted in a PWM mode. The longer the PWM duty cycle is, the faster the speed is.

The transmission line set 44 includes a power line 443 and a ground line 444 to transfer power from the second circuit board 38 to the first circuit board 36. In response to the rotation command of the operation signal, the transmission line set 44 includes a rotation direction signal line 445. The driving signal generated by the second controller 382 according to the rotation command of the operation signal includes a rotation direction command, which is transmitted through the rotation direction signal line 445. After receiving the driving signal, the first controller 366 controls the commutating switch components 362 according to the rotation direction command, so that the rotor rotates according to the rotation direction set by the rotation switch of the operation interface 32. The transmission line set 44 further includes a current signal line 446. The driving signal includes a current command for setting the current during operation of the motor 34. The current command is transmitted through the current signal line 446. After receiving the driving signal, the first controller 366 controls the commutating switch components 362 according to the current command to limit the current during operation of the motor 34. The current command is transmitted in the PWM mode in this embodiment. The longer the PWM duty cycle is, the more the current is.

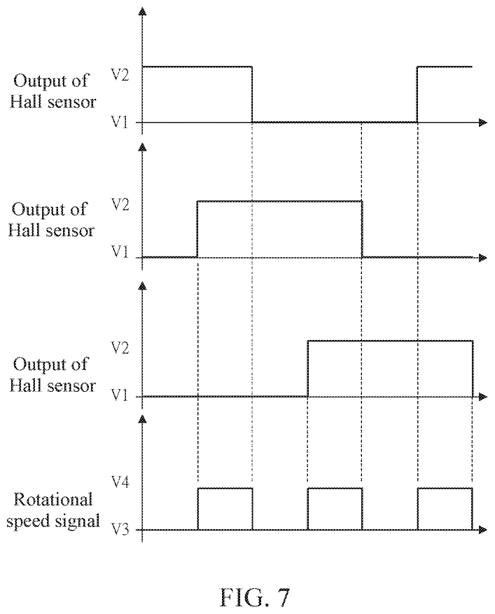

In order to facilitate the second controller 382 to obtain the rotational speed of the rotor of the motor, the transmission line set 44 in the present embodiment includes a rotational speed signal line 447. The first controller 366 converts the position signal sensed by the three Hall sensors 364 into a rotational speed signal, which is then transmitted to the second controller 382 through the rotational speed signal line 447. The second controller 382 determines the rotational speed of the motor 34 based on the rotational speed signal. With reference to FIG. 7, in this embodiment, the method of converting the position signal into the rotational speed signal is described as what follows. When the output of each of the Hall sensors 364 is changed from the first voltage level V1 to the second voltage level V2, the first controller 366 changes the rotational speed signal from a third voltage level V3 to a fourth voltage level V4; and when the output of each of the Hall sensors 364 is changed from the second voltage level V2 to the first voltage level V1, the first controller 366 changes the rotational speed signal from the fourth voltage level V4 to the third voltage level V3. In the embodiment, the third voltage level V3 is exemplified by a low voltage level, and the fourth voltage level V4 is exemplified by a high voltage level. In other words, every 120 degrees of rotation of the rotor, the rotational speed signal will have a pulse wave change of one cycle; and per revolution of the rotor, the rotational speed signal will have three cycles of pulse wave. The second controller 382 can calculate the rotational speed of the rotor from the pulse wave cycle of the rotational speed signal, whereby the outputs of the three Hall sensors 364 are integrated into one to effectively reduce the number of signal lines of the transmission line set 44. In practice, the first controller 366 can also use the output of one of the Hall sensors 364 from the position signal as the rotational speed signal, and the second controller 382 calculates the rotational speed of the rotor from the pulse wave cycle outputted by one Hall sensors 364.

In addition, if the second controller 382 does not need to obtain the rotational speed, the rotational speed signal line 447 may not be provided. Moreover, if it is needed to obtain the temperature of the commutating switch component 362 by the second controller 382, a temperature sensor (not shown) may be disposed on the first circuit board 36, and the temperature of the commutating switch component 362 may be measured by the temperature sensor. The transmission line set 44 can include a temperature signal line (not shown) for transmitting the output signal of the temperature sensor to the second controller 382.

According to the above description, the power tool of the present invention additionally provided the first circuit board 36 with the first controller 366, which controls the switching of the commutating switch components 362, thereby effectively reducing the number of signal line of the transmission line set 44 and facilitating the wiring of the transmission line set 44 in the limited space between the handheld portion 304 and the transmission portion 302 of the housing 30.

It must be pointed out that the embodiments described above are only some embodiments of the present invention. All equivalent structures which employ the concepts disclosed in this specification and the appended claims should fall within the scope of the present invention.

What is claimed is:

1. A power tool, comprising:
a housing comprising a transmission portion and a handheld portion;
a motor disposed in the transmission portion;
a first circuit board disposed in the transmission portion of the housing and provided with a plurality of commutating switch components, a plurality of Hall sensors and a first controller, wherein the first controller is electrically connected to the commutating switch components and the Hall sensors; the commutating switch components are electrically connected to the motor; the Hall sensors sense a position of a rotor of the motor and generate a position signal; and the first controller receives a driving signal and controls the commutating switch components to perform commutation according to the driving signal and the position signal in order to rotate the rotor of the motor; and
a second circuit board disposed in the handheld portion of the housing, electrically connected to the first circuit board through a transmission line set, and provided with a second controller, which transmits the driving signal to the first controller via the transmission line set.

2. The power tool of claim 1, wherein the transmission line set includes a speed signal line and a brake signal line; the driving signal includes a speed command and a braking command; the speed command is transmitted through the speed signal line; and the braking command is transmitted through the brake signal line.

3. The power tool of claim 2, wherein the speed command is transmitted in a PWM mode.

4. The power tool of claim 2, wherein the transmission line set further comprises a rotation direction signal line; the driving signal includes a rotation direction command; and the rotation direction command is transmitted through the rotation direction signal line.

5. The power tool of claim 2, wherein the transmission line set further comprises a current signal line; the driving signal includes a current command; and the current command is transmitted through the current signal line.

6. The power tool of claim 5, wherein the current command is transmitted in a PWM mode.

7. The power tool of claim 1, wherein the transmission line set includes a rotational speed signal line; the first controller converts the position signal into a rotational speed signal; the rotational speed signal is transmitted to the second controller through the rotational speed signal line; and the second controller determines a rotational speed of the motor according to the rotational speed signal.

8. The power tool of claim 7, wherein an output of each of the Hall sensors is changed between a first voltage level and a second voltage level; the first controller changes the rotational speed signal from a third voltage level to a fourth voltage level when the output of each of the Hall sensors is changed from the first voltage level to the second voltage level; and the first controller changes the rotational speed signal from the fourth voltage level to the third voltage level when the output of each of the Hall sensors is changed from the second voltage level to the first voltage level.

9. The power tool of claim 1, wherein the motor comprises a body, a rear cover disposed on the body, and a heat dissipation pad disposed between the rear cover and the body; the first circuit board is disposed between the body and the heat dissipation pad, and the commutating switch components have a heat conduction relationship with the heat dissipation pad.

10. The power tool of claim 9, wherein the heat dissipation pad has another heat conduction relationship with the rear cover.
